(19) United States
(12) Patent Application Publication
(10) Pub. No.: US 2023/0299286 A1
(43) Pub. Date: Sep. 21, 2023

(54) TMCCC ELECTRODE

(71) Applicant: Natron Energy, Inc., Santa Clara, CA (US)

(72) Inventors: Rachel Ailey Altmaier, Cupertino, CA (US); Peter Benjamin Herman, San Jose, CA (US); Meet A. Vora, Santa Clara, CA (US); Ali Firouzi, Saratoga, CA (US); Mai Fujimoto, Fremont, CA (US)

(73) Assignee: Natron Energy, Inc., Santa Clara, CA (US)

(21) Appl. No.: 17/695,440

(22) Filed: Mar. 15, 2022

(51) Int. Cl. H01M 4/58; H01M 4/62

(52) U.S. Cl. CPC H01M 4/5825; H01M 4/622; H01M 4/625

(57) ABSTRACT

A system and method for implementing and manufacturing a polymer system for use with an electrode that includes a transition metal cyanide coordination compound (TMCCC), conductive material, and a binder system including a polymer selected from the thermoplastic elastomer family.

### FIELD OF THE INVENTION

The present invention relates generally to electrochemical cells including a coordination compound electrochemically active in one or more conductive structures in such cells, and more specifically, but not exclusively, to an improvement in electrochemical cells having one or more electrodes including one or more transition metal cyanide coordination compounds.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

There are a range of aqueous and non-aqueous polymer systems used in electrochemical cells, such as polyvinylidene fluoride (PVDF) and PVDF co-polymers commonly dissolved in n-methyl pyrrolidone (NMP) for use in lithium-ion batteries. An aqueous alternative is a combination of carboxymethyl cellulose (CMC) and styrene-butadiene rubber (SBR).

There are well-known disadvantages to these polymer systems including the case of a high boiling point for NMP. The high boiling point means a high drying temperature is used during roll-to-roll coating. While that may be suitable for lithium-ion electrochemical cells, TMCCCs decompose above 120° C., and therefore this solvent and its use is not practical for use in manufacturing electrodes and conductive structures containing TMCCC. Additionally, when used in a thick coat (300 μm or more), PVDF results in a brittle coat that cannot withstand a bend test. FIG. 1 illustrates a TMCCC electrode that includes PVDF providing a representative brittle coat. The TMCCC electrode of FIG. 1 is made with PVDF and has been bent over a ⅛″ mandrel. The coat exhibits severe cracking such that a foil substrate is left exposed.

A CMC/SBR system does not provide adequate cohesive strength—deep cracks form during drying, effectively splitting the coat into very small pieces. FIG. 2 illustrates A TMCCC coat made with CMC/SBR is shown after drying. FIG. 3 illustrates this dried coat of FIG. 3 folded over a ⅛″ mandrel where the coat can be seen with cracks extending down to the foil substrate. Small pieces of the coat have flaked off, leaving bare foil exposed at the left of the coated strip.

There may be benefits to an appropriately implemented polymer system for use with a TMCCC-containing electrically-conductive structure (e.g., an electrode) as well as methods for use and manufacturing.

### BRIEF SUMMARY OF THE INVENTION

Disclosed is a system and method for implementing and manufacturing a polymer system for use with an electrode that includes a transition metal cyanide coordination compound (TMCCC), conductive material, and a binder system including a polymer selected from the thermoplastic elastomer family. The following summary of the invention is provided to facilitate an understanding of some of the technical features related to electrodes including TMCCC materials (and methods for their manufacture), and is not intended to be a full description of the present invention. A full appreciation of the various aspects of the invention can be gained by taking the entire specification, claims, drawings, and abstract as a whole. The present invention is applicable to other electrochemically active compounds in addition to TMCCC materials, for example other coordination materials, and to other electrically-conductive structures that include a coordination material.

An embodiment may make use of a binder system for a TMCCC-containing electrode that has a thermoplastic elastomer enabling thick coats (300 μm or more per side of a substrate in dry thickness) with good cohesive and adhesive properties. One implementation includes one or more TMCCC electrochemical cell electrodes made with a binder system including a polymer from a thermoplastic elastomer family. Some embodiments and implementations may include components in the binder system, such as block co-polymers, sometimes functionalized with a polar side group, and/or an elastomeric component that may include a rubber mixture (e.g., synthetic, natural, or a combination).

Another embodiment may include an electrochemical cell having one or more TMCCC-containing conductive structures (e.g., electrodes) manufactured using a binder system with a polymer from a thermoplastic elastomer family, and assembled into an operational secondary cell.

An embodiment may include an electrically conductive structure for an electrochemical cell, including an electrochemically active material including a TMCCC; a conductive material; and a binder system configured to bind the electrochemically active material to the conductive material, the binder system including a polymer selected from a thermoplastic elastomer family.

An embodiment may include an electrochemical cell including a positive electrode, a negative electrode, and an electrolyte, wherein one of the electrodes includes a TMCCC, a conductive material, and a binder system including a polymer of the thermoplastic elastomer family.

A embodiment may include a method manufacturing an electrically conductive structure for an electrochemical cell, including a) providing an electrochemically active material including a TMCCC; b) providing a conductive material; and c) binding the electrochemically active material to the conductive material using a binder system that includes a polymer selected from a thermoplastic elastomer family.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a TMCCC electrode that includes PVDF;

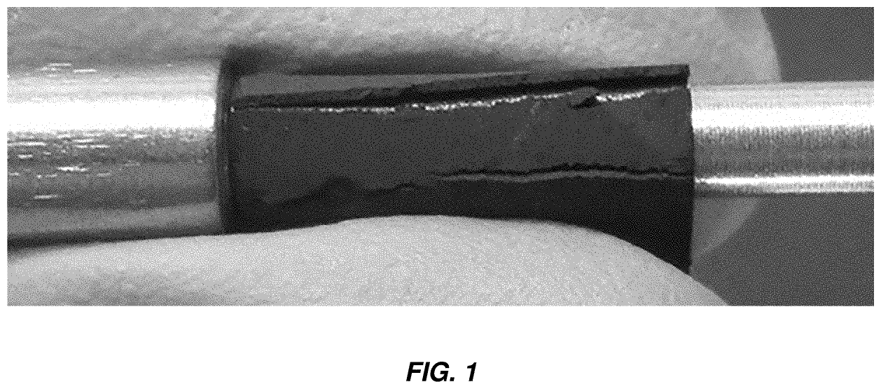

FIG. 2 illustrates a TMCCC coating;

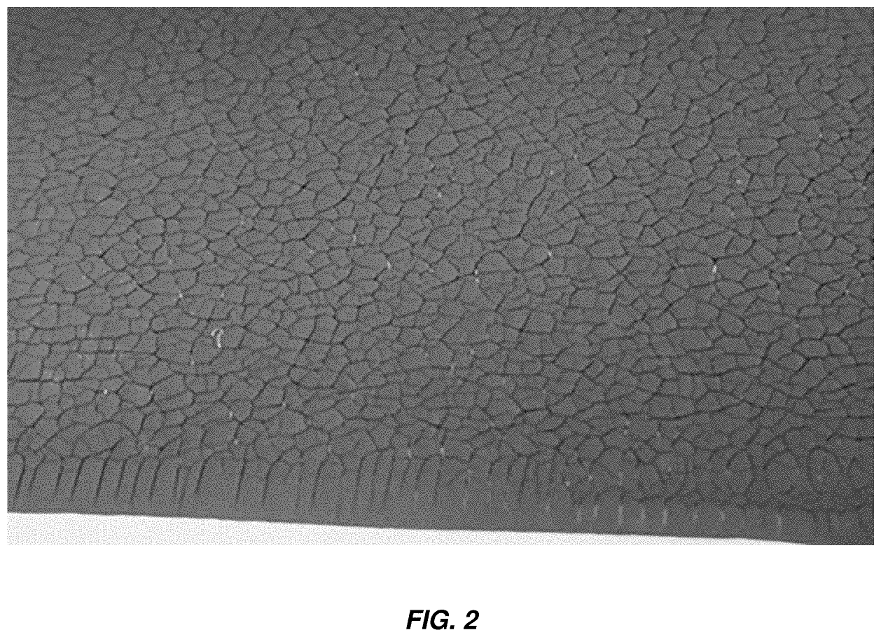

FIG. 3 illustrates the TMCCC coating of FIG. 2 folded over a ⅛ inch mandrel;

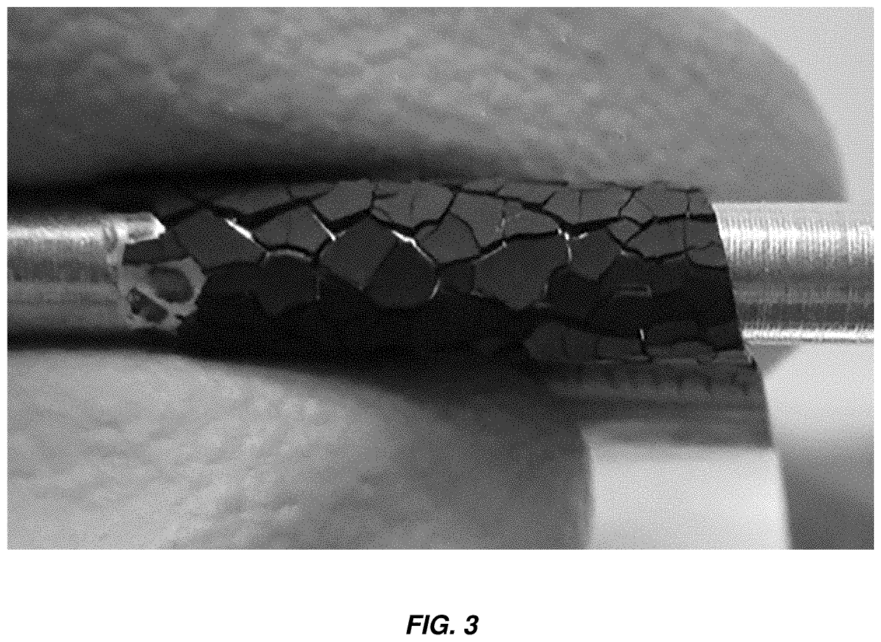

FIG. 4 illustrates a flow curve of a TMCCC-containing slurry;

FIG. 5 illustrates a strip of a coating including an embodiment of the present invention;

FIG. 6 illustrates a first scanning electron microscope image of a coating at a first resolution;

FIG. 7 illustrates a first scanning electron microscope image of the coating of FIG. 6 at a second resolution;

FIG. 8 illustrates an electrochemical impedance spectrum;

FIG. 9 illustrates a scanning electron microscope image of a TMCCC-containing electrode;

FIG. 10 illustrates a Scanning Electron Microscope image of a cross-section of a TMCCC-containing electrode;

FIG. 11 illustrates an electrochemical impedance spectrum of a cell including a TMCCC-containing electrode;

FIG. 12 illustrates a flow curve of a slurry containing a TMCCC;

FIG. 13 illustrates a scanning electron microscope image of a cross-section of a TMCCC-containing electrode;

FIG. 14 illustrates a voltage curve of a cell including a TMCCC-containing electrode;

FIG. 15 illustrates an electrochemical impedance spectrum of a cell including a TMCCC-containing electrode;

FIG. 16 illustrates a flow curve of a slurring including a TMCCC;

FIG. 17 illustrates a voltage curve of a cell including a TMCCC-containing electrode;

FIG. 18 illustrates an electrochemical impedance spectrum of a cell including a TMCCC-containing electrode;

FIG. 19 illustrates a scanning electron microscope of a slurry containing a TMCCC;

FIG. 20 illustrates a flow curve of a slurry containing a TMCCC;

FIG. 21 illustrates a voltage curve of a cell including a TMCCC-containing electrode;

FIG. 22 illustrates an electrochemical impedance spectrum of a cell including a TMCCC-containing electrode;

FIG. 23 illustrates a flow curve of a slurry including a TMCCC;

FIG. 24 illustrates a scanning electron microscope image of a slurry including a TMCCC;

FIG. 25 illustrates a flow curve of a slurry including a TMCCC;

FIG. 26 illustrates a scanning electron microscope image of a slurry including a TMCCC; and

FIG. 27 illustrates a generic electrochemical cell.

### DETAILED DESCRIPTION OF THE INVENTION

Embodiments of the present invention provide a system and method improving electrochemical cell manufacturing by implementing and manufacturing a polymer system for use with an electrode that includes a transition metal cyanide coordination compound (TMCCC), conductive material, and a binder system including a polymer selected from the thermoplastic elastomer family. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### Definitions

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to certain embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable properties that are substantially the same as those of the non-spherical object. Thus, for example, a size of a non-spherical object can refer to a diameter of a corresponding spherical object that exhibits light scattering or other properties that are substantially the same as those of the non-spherical object. Alternatively, or in conjunction, a size of a non-spherical object can refer to an average of various orthogonal dimensions of the object. Thus, for example, a size of an object that is a spheroidal can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

As used herein, the term “electrode” in the context of an electrochemical cell may have different meanings and sometimes encompass different sets of components of the electrochemical cell in different contexts and different audiences. For example, the electrode, as comprised by the TMCCC, carbon, and binder, as well as the solvents used in the slurry processing to make the electrode, is typically considered to be entirely separate from a current collector. This electrode structure could be deposited on any number of current collectors having different compositions (aluminum, copper, etc.) or mechanical properties (thickness, surface roughness, and the like). One precise definition would be to refer to an “electrode” as comprising two components: both an “active layer” or “electrode composite” including the TMCCC, carbons, and binders, as well as a current collector, which may in turn have subcomponents such as a special surface coating, or special design features such as physical dimensions. The present application has adopted a special term used herein to avoid some imprecision that is present when referring to an electrode of an electrochemical cell. This term is “electrically conductive structure” and includes electrodes as well as other electrochemically-active structures that may be used as an electrode. Some larger structures that encompass an electrode may also be such an “electrically conductive structure” within the meaning of the present application, unless the context would reasonably suggest otherwise to a person having ordinary skill in the art apprised of this disclosure and understanding of the discussion and claims presented herein.

Described herein is a new class of polymer system for an electrochemical cell having an architecture based on conductive structures (e.g., electrodes) that contain transition metal cyanide coordination compound (TMCCC) materials as electrochemically active materials.

A battery electrode includes a film having a mixture of electronically active material, a conductive material, and a polymer, which is adhered to a conductive substrate. The film functions as a mixed conductor, with both electronic and ionic conductivity. To achieve electronic conductivity, the film has a solid phase with a backbone of conductive elements that enables electron transport to the active material and the current collector. To achieve ionic conductivity, the film has a continuous phase of pores accessible to the battery electrolyte, enabling ion transport. The structure of the electrode is critical to battery function.

When present, a polymer within the electrode plays critical roles during electrode fabrication as well as subsequent usage. To make an electrode, the components are first mixed in a liquid medium to form a slurry. The polymer may adsorb to the conductive material or the active material and prevent clumping through steric hindrance. It may remain in the free volume of the slurry and increase viscosity, which increases shear force during mixing and improves dispersion.

The slurry is then deposited onto a current collector and dried to remove the solvent and create a porous structure. It may be dried via conduction, convection, or radiation. During this drying process, the slurry microstructure may have sufficient strength to resist binder migration and particle sedimentation. In the dry film, the polymer binder may provide sufficient cohesive strength to hold the components (active material, conductive aid, and the like) firmly. It may also provide sufficient adhesive strength to bind the coated material to the current collector.

The electrode undergoes additional stresses during roll-to-roll processing—it may be wound over rollers, sheared or punched, and possibly wound tightly within the final product, so it may be able to bend without cracks or delamination. It may also be sufficiently flexible to withstand compression, as the coat may be run through a calender press to reduce thickness to meet product thickness specifications and to improve electronic conductivity by improving contact between the active and conductive material. Since the polymer is a non-conductive component, it adds some resistance to the electrode, so the polymer may desirably accomplish these functions at a low weight percent.

In one embodiment, an active material includes a TMCCC and the cell is a sodium-ion battery. A specific capacity of a TMCCC is relatively low in comparison to a lithium-ion battery material, a very thick electrode coat may be preferred in order to achieve a reasonable energy output. The choice of polymer binder can therefore be critical.

As used herein, the term “thermoplastic elastomer” (TPE) is a block co-polymer that exhibits thermoplastic and viscoelastic properties. A thermoplastic material is held together by weak intermolecular forces that weaken when the polymer is heated, resulting in pliability and flow. The material then hardens when cooled. An elastomeric material is an amorphous polymer deformable at room temperature. A TPE includes both hard and soft blocks, giving it the mechanical properties of an elastomer but allowing it to be processed like a thermoplastic. It typically includes two glass transition temperatures, with the values dependent on the properties of each block. It may have a variety of structures, such as AB, ABA, (AB)n, and the like, where A represents a hard block and B represents a soft block.

An embodiment includes an electrode including a TMCCC active material, a conductive aid, and a binder or mixture of binders including a thermoplastic elastomer adhered to a conductive substrate.

The conductive aid may be carbon black, graphite, carbon nanofiber, carbon nanotubes, or a mixture of two or more of these. The conductive particles may be nanoparticles, micron particles, or a mixture of both.

The hard block of the thermoplastic elastomer may be polystyrene, polyurethane, polyester, or polyamide. The soft block may be polyether, polyester, polybutadiene, polyisoprene, poly(ethylene-butylene), or poly(ethylene-propylene). The polymer may be functionalized with polar side groups. These side groups may include one or more of hydroxyl, carboxylates, aldehydes, acid anhydrides, carbonyl, carbonate, esters, acetals, acyl halides, halides, amides, amines, nitriles, sulfoxides, sulfones, sulfonic acids, phosphates, phosphonic acids, or other polar functional groups. The binder component of the composite electrode may further include a mixture of two or more of these polymers. The thermoplastic elastomer may also be mixed with a thermoset synthetic or natural rubber, such as ethylene propylene rubber or ethylene propylene diene monomer rubber.

Presented below are examples 1-7 that reference one or more of the following figures.

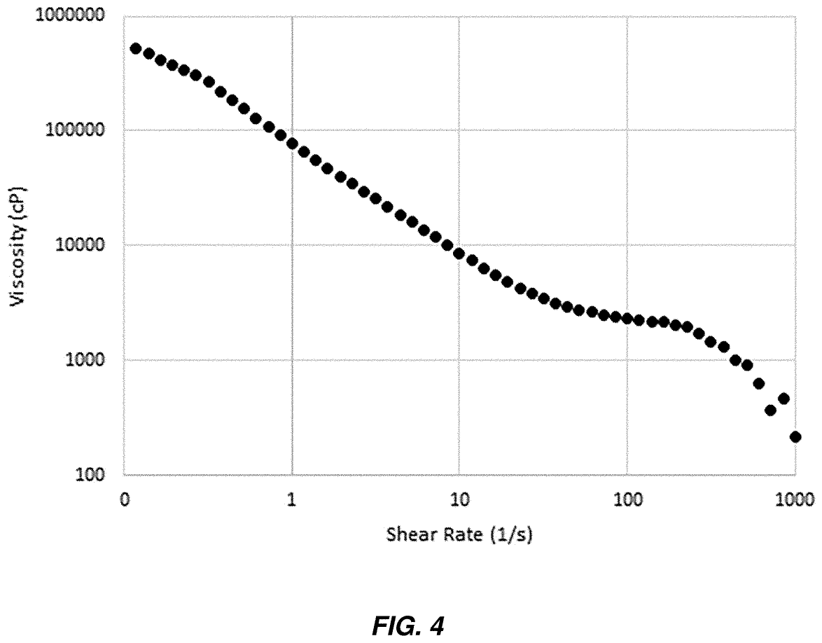

FIG. 4 illustrates a flow curve of a slurry containing a TMCCC, conductive carbon, and styrene-ethylene/butylene-styrene functionalized with a maleic anhydride pendant group.

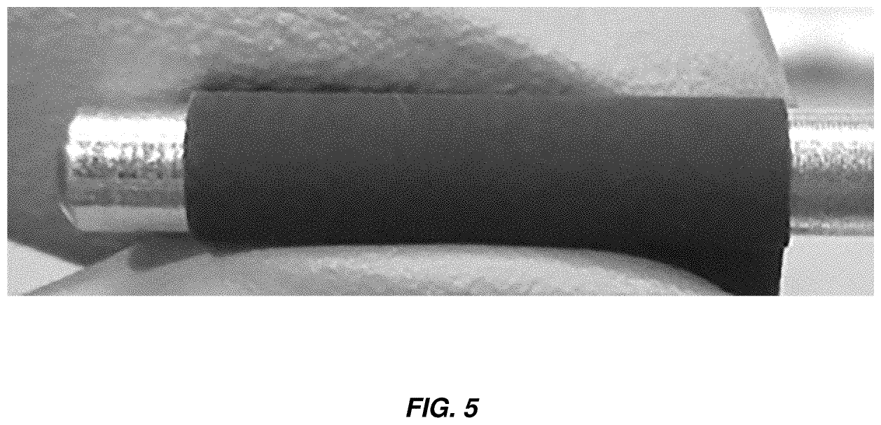

FIG. 5 illustrates a strip of a coat containing a TMCCC, conductive carbon, and styrene-ethylene/butylene-styrene functionalized with a maleic anhydride pendant group is bent over a ⅛″ mandrel. The coat does not exhibit any cracking or delamination.

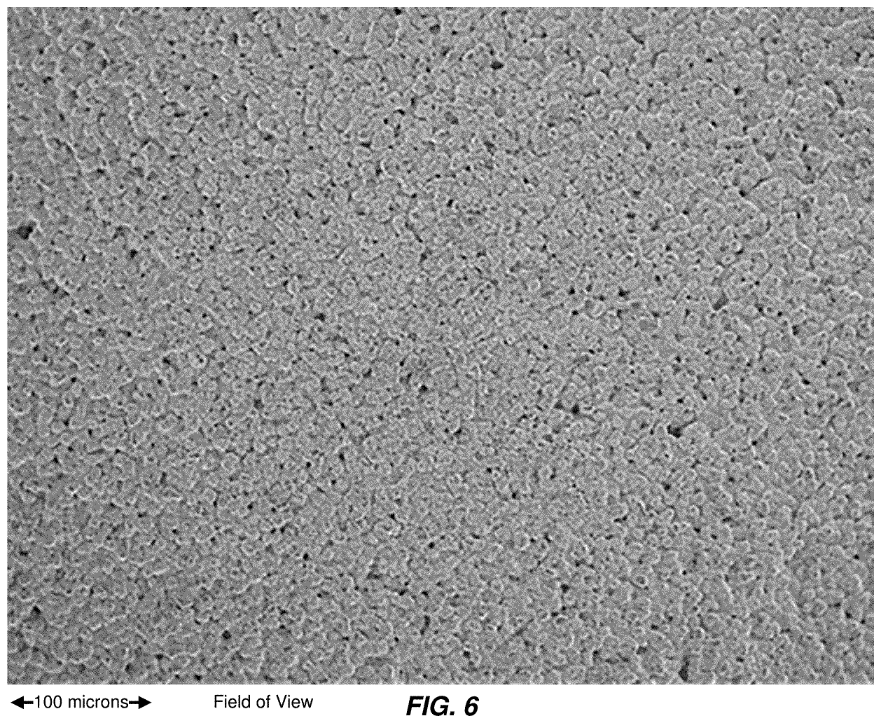

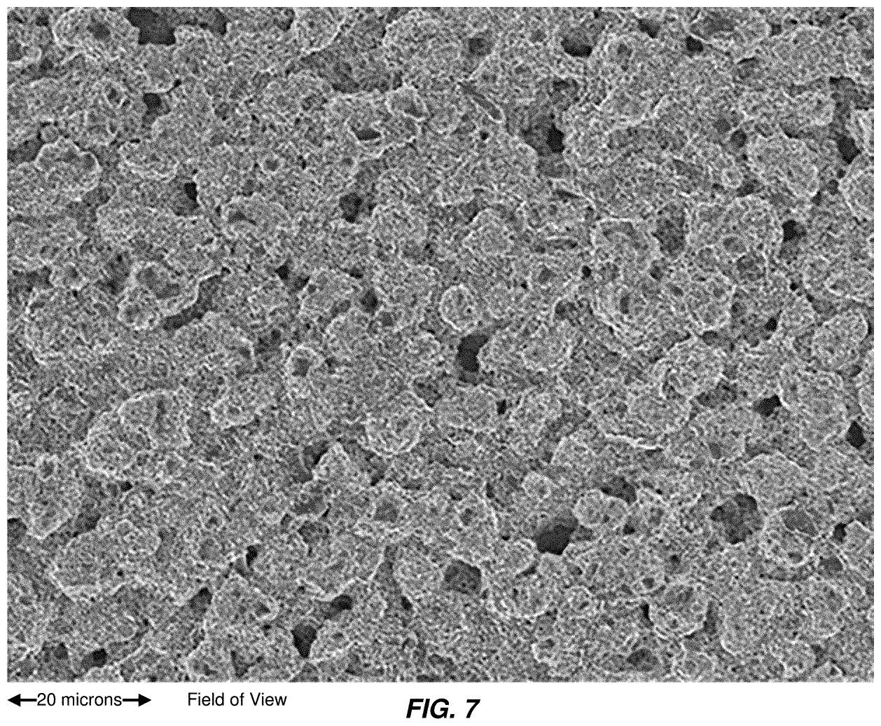

FIG. 6 and FIG. 7 illustrate a set of scanning electron microscope images, at different resolutions, of an electrode comprised of a TMCCC, conductive carbon, graphite, and styrene-ethylene/butylene-styrene functionalized with a maleic anhydride pendant group.

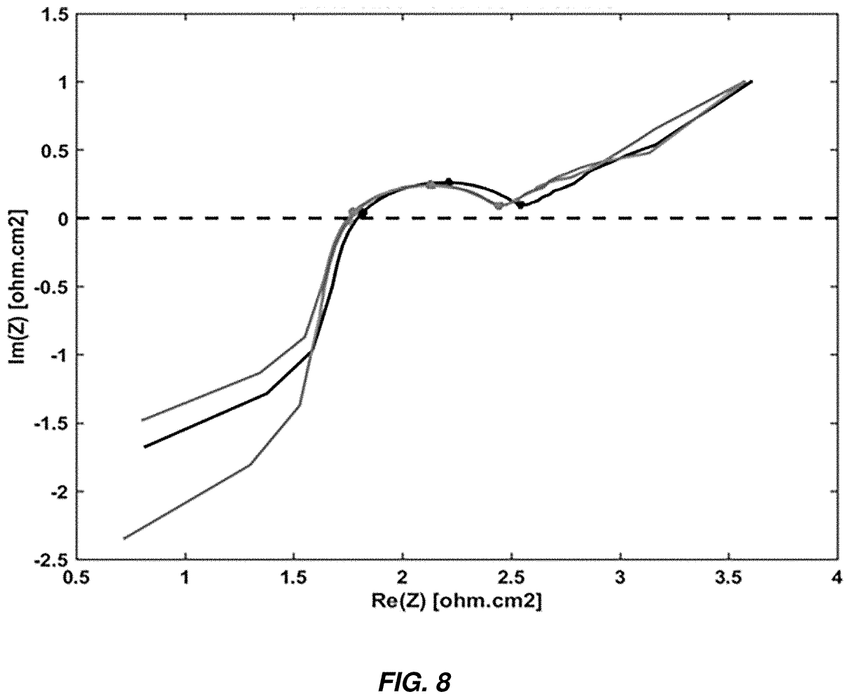

FIG. 8 illustrates an Electrochemical impedance spectrum of a cell containing an electrode comprised of a TMCCC, conductive carbon, graphite, and styrene-ethylene/butylene-styrene functionalized with a maleic anhydride pendant group.

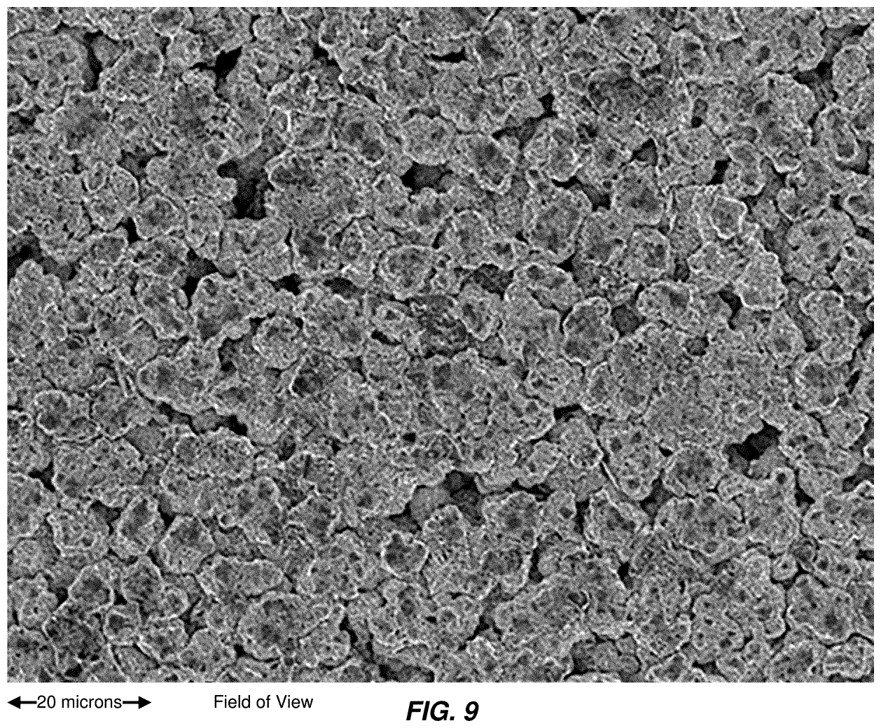

FIG. 9 illustrates a Scanning Electron Microscope image of an electrode comprised of a TMCCC, conductive carbon, graphite, styrene-ethylene/butylene-styrene, and styrene-ethylene/butylene-styrene functionalized with a maleic anhydride pendant group.

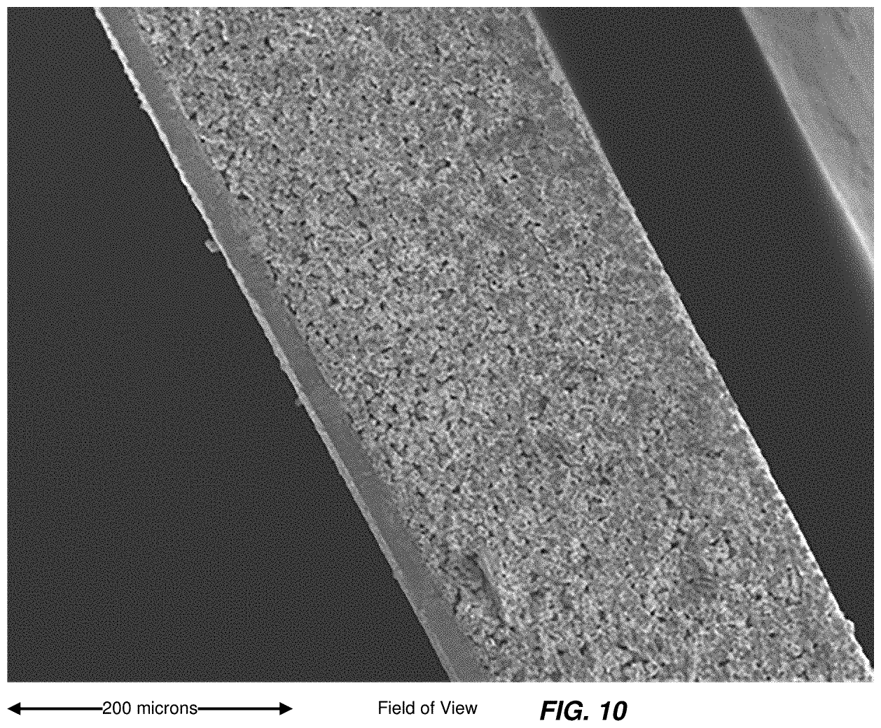

FIG. 10 illustrates a Scanning Electron Microscope image of a cross-section of an electrode comprised of a TMCCC, conductive carbon, graphite, styrene-ethylene/butylene-styrene, and styrene-ethylene/butylene-styrene functionalized with a maleic anhydride pendant group adhered to a foil substrate.

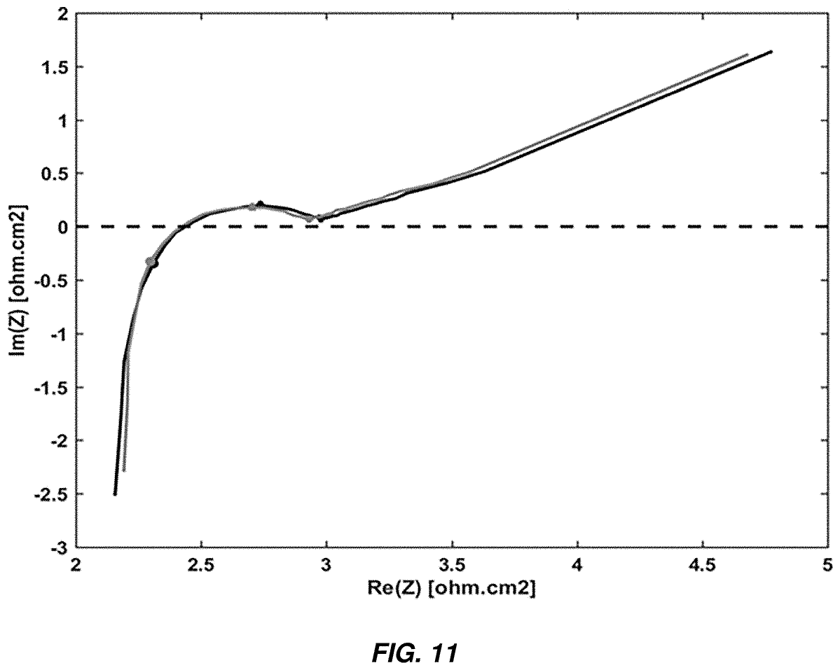

FIG. 11 illustrates an Electrochemical impedance spectrum of a cell containing an electrode comprised of a TMCCC, conductive carbon, graphite, styrene-ethylene/butylene-styrene, and styrene-ethylene/butylene-styrene functionalized with a maleic anhydride pendant group.

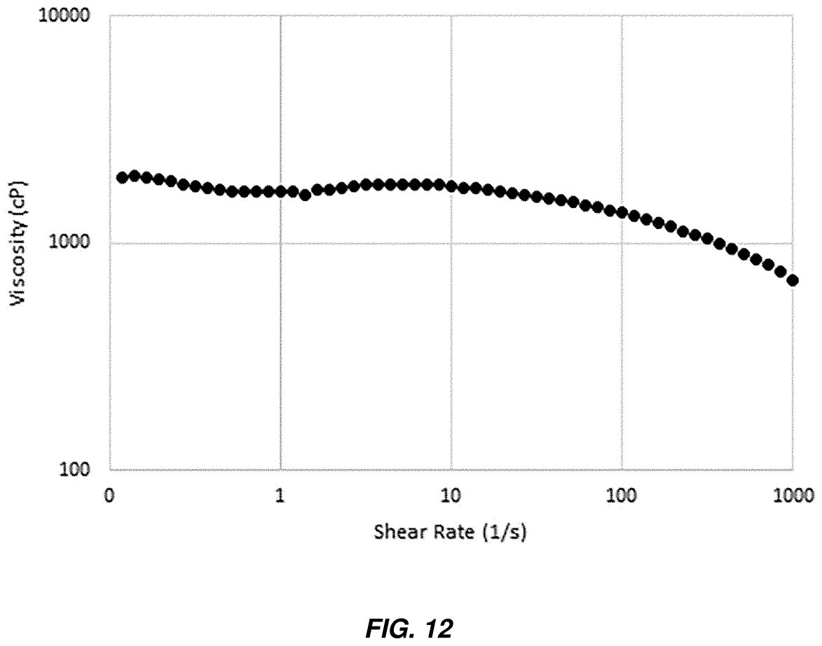

FIG. 12 illustrates a Flow curve of a slurry containing a TMCCC, conductive carbon, styrene-ethylene/butylene-styrene of two different molecular weights, and styrene-ethylene/butylene-styrene functionalized with a maleic anhydride pendant group.

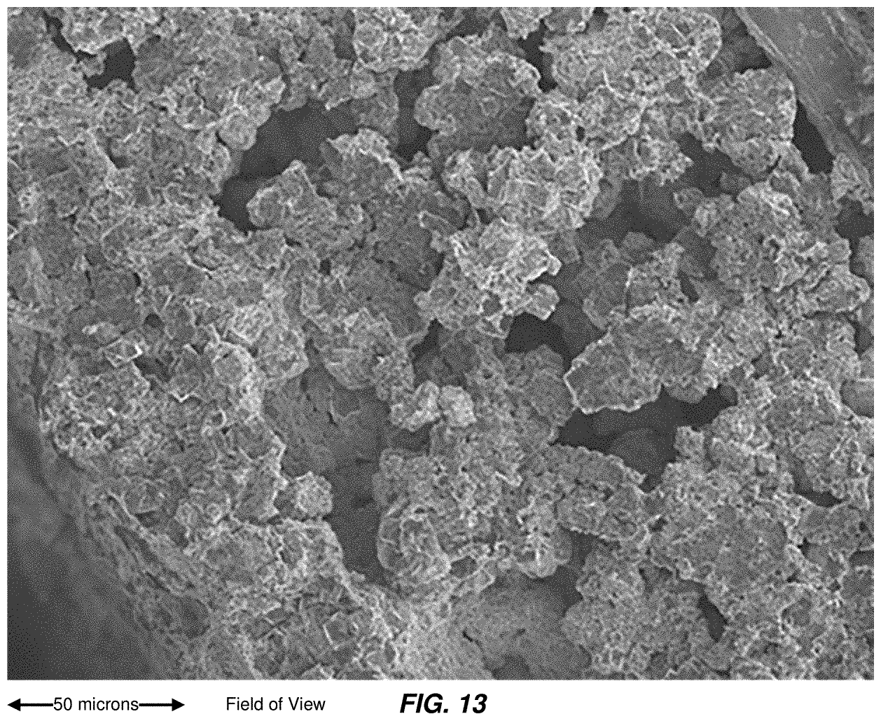

FIG. 13 illustrates a Scanning Electron Microscope image of a cross-section of an electrode comprised of a TMCCC, conductive carbon, styrene-ethylene/butylene-styrene of two different molecular weights, and styrene-ethylene/butylene-styrene functionalized with a maleic anhydride pendant group adhered to a foil substrate.

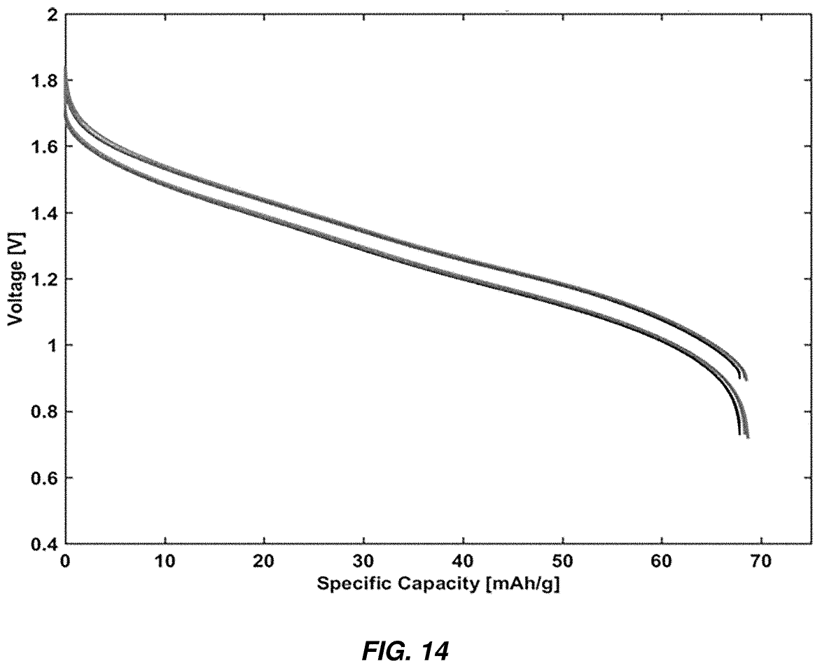

FIG. 14 illustrates a Voltage curve of a cell containing an electrode comprised of a TMCCC, conductive carbon, styrene-ethylene/butylene-styrene of two different molecular weights, and styrene-ethylene/butylene-styrene functionalized with a maleic anhydride pendant group adhered to a foil substrate.

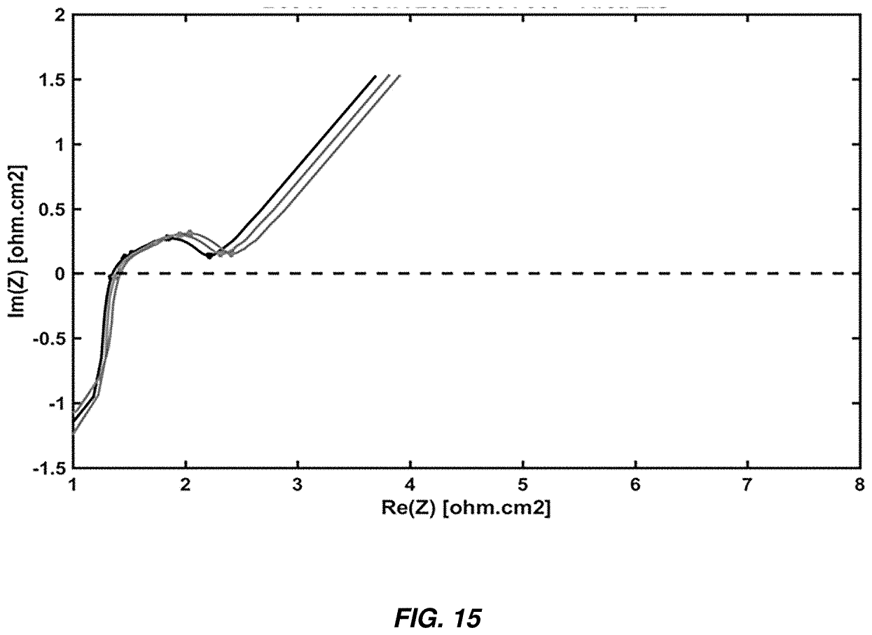

FIG. 15 illustrates an Electrochemical impedance spectrum of a cell containing an electrode comprised of a TMCCC, conductive carbon, styrene-ethylene/butylene-styrene of two different molecular weights, and styrene-ethylene/butylene-styrene functionalized with a maleic anhydride pendant group adhered to a foil substrate.

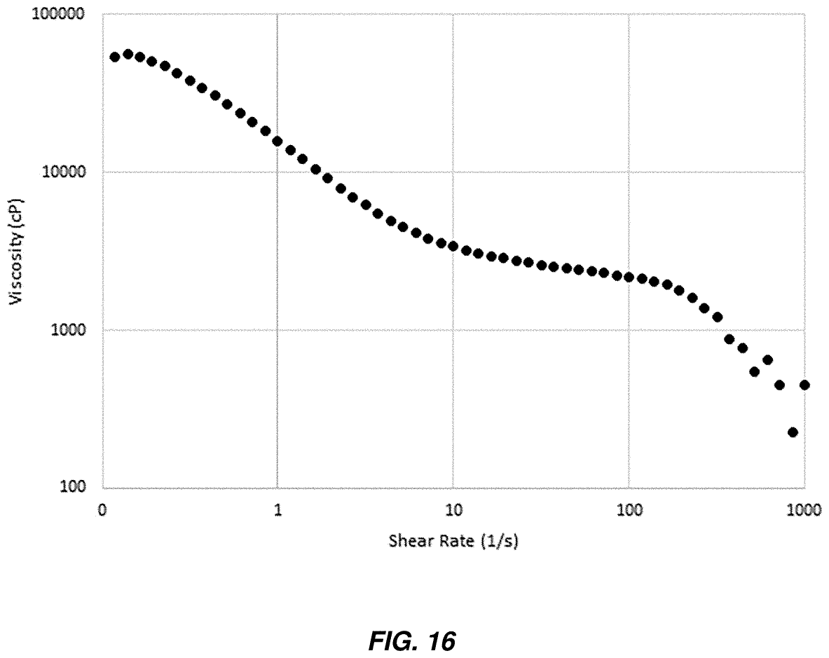

FIG. 16 illustrates a Flow curve of a slurry containing a TMCCC, conductive carbon, styrene-ethylene/butylene-styrene, styrene-ethylene/propylene-styrene, and styrene-ethylene/butylene-styrene functionalized with a maleic anhydride pendant group.

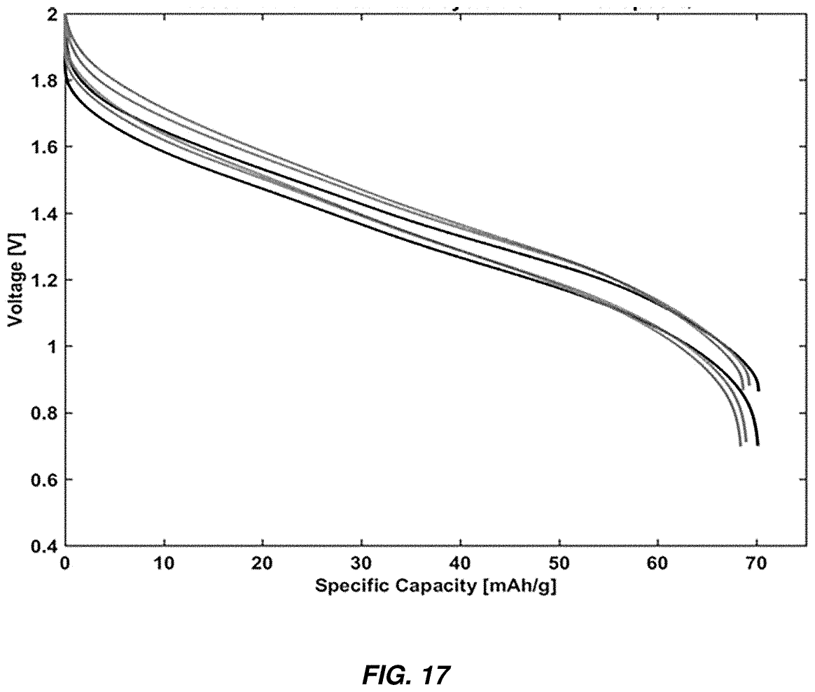

FIG. 17 illustrates a Voltage curve of a cell containing an electrode comprised of a TMCCC, conductive carbon, styrene-ethylene/butylene-styrene, styrene-ethylene/propylene-styrene, and styrene-ethylene/butylene-styrene functionalized with a maleic anhydride pendant group.

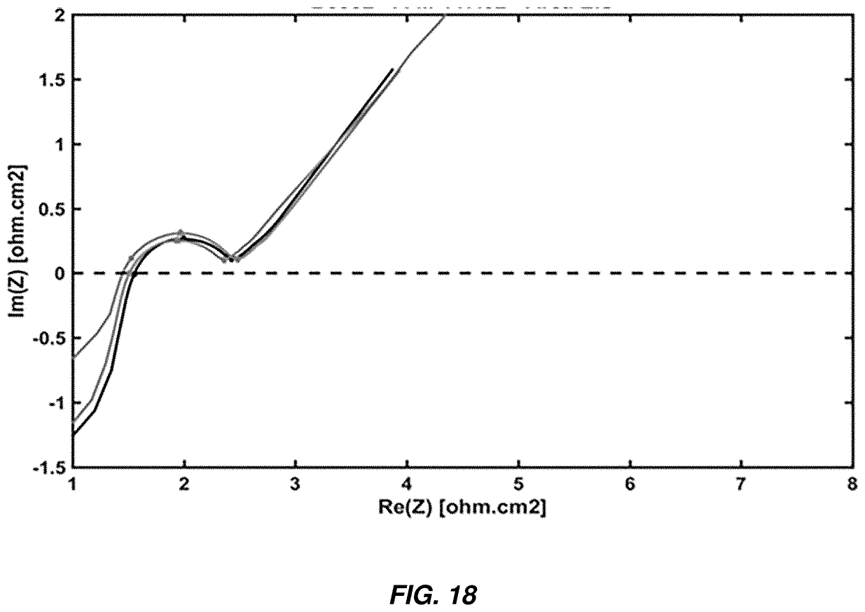

FIG. 18 illustrates an Electrochemical impedance spectrum of a cell containing an electrode comprised of a TMCCC, conductive carbon, styrene-ethylene/butylene-styrene, styrene-ethylene/propylene-styrene, and styrene-ethylene/butylene-styrene functionalized with a maleic anhydride pendant group.

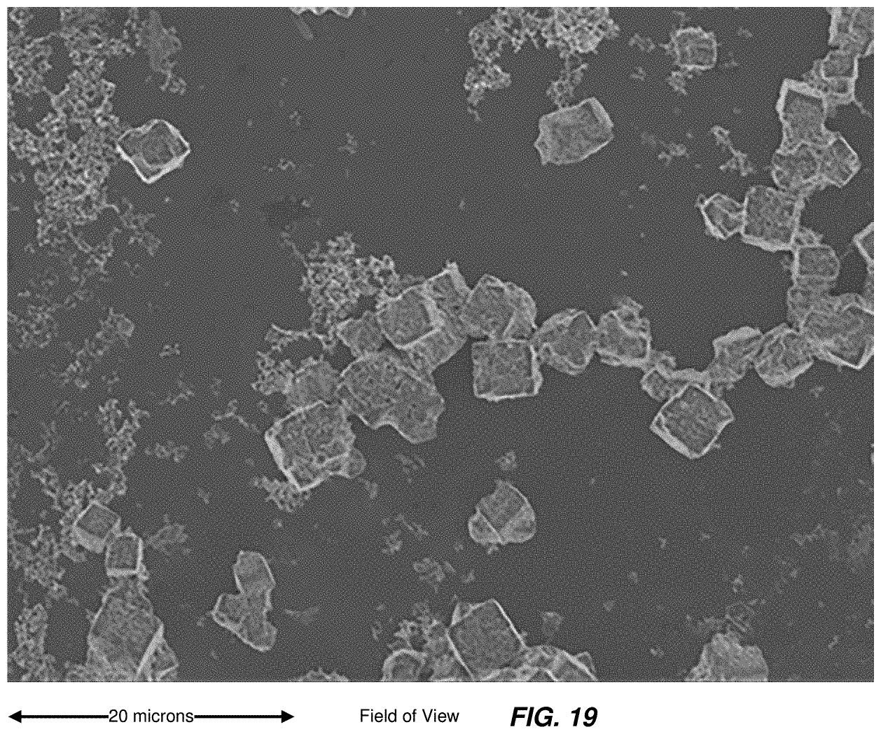

FIG. 19 illustrates a Scanning electron microscope image of a slurry containing a TMCCC, conductive carbon, ethylene/propylene, and styrene-ethylene/butylene-styrene.

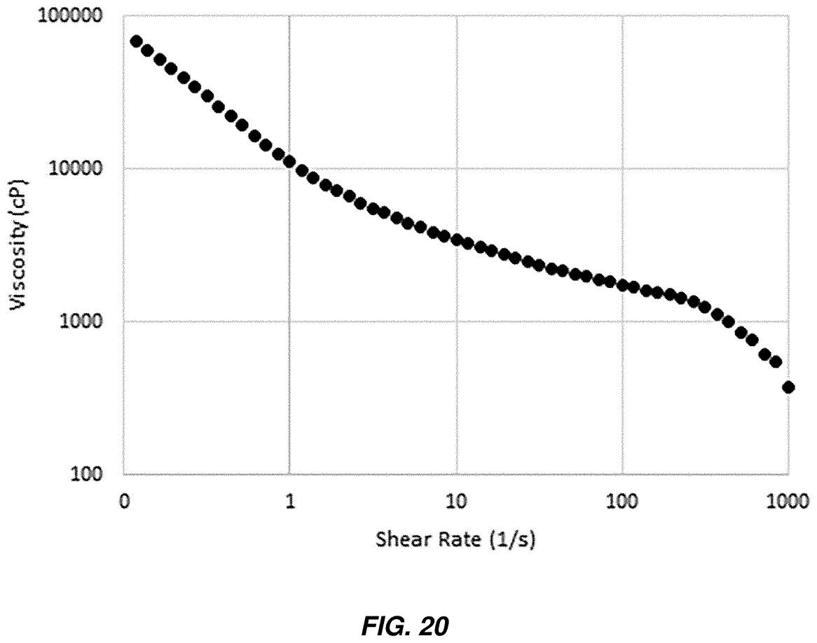

FIG. 20 illustrates a Flow curve of a slurry containing a TMCCC, conductive carbon, ethylene/propylene, and styrene-ethylene/butylene-styrene.

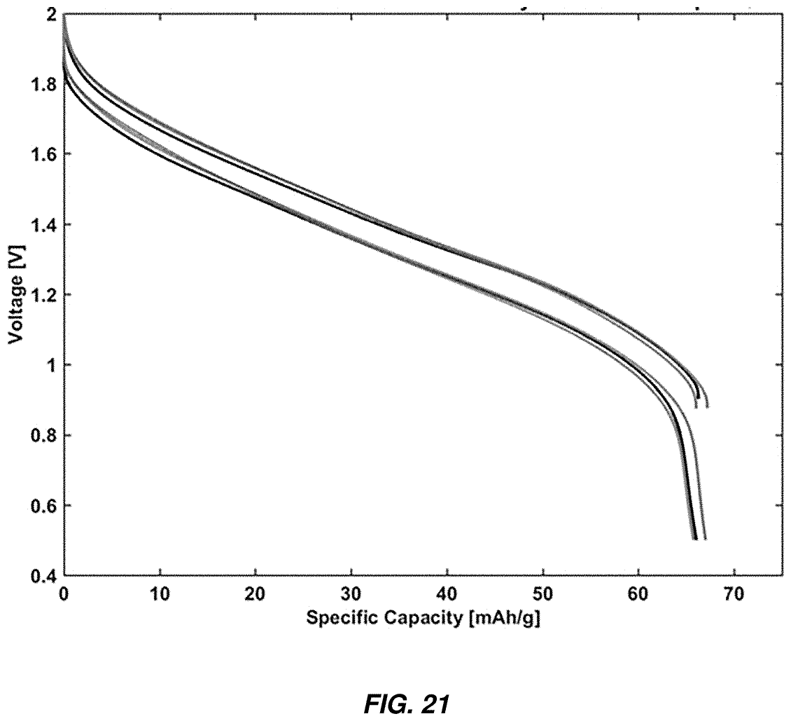

FIG. 21 illustrates a Voltage curve of a cell containing an electrode comprised of a TMCCC, conductive carbon, ethylene/propylene, and styrene-ethylene/butylene-styrene.

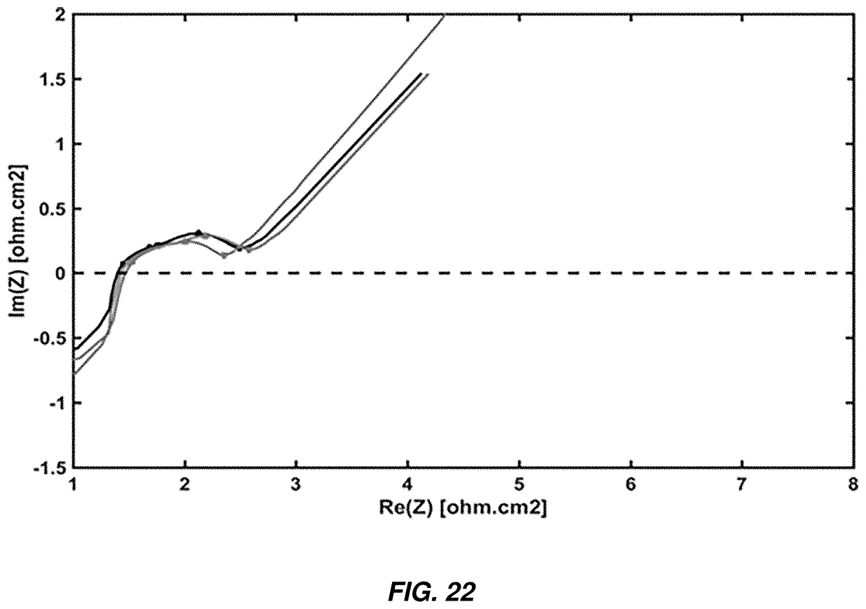

FIG. 22 illustrates an Electrochemical impedance spectrum of a cell containing an electrode comprised of a TMCCC, conductive carbon, ethylene/propylene, and styrene-ethylene/butylene-styrene.

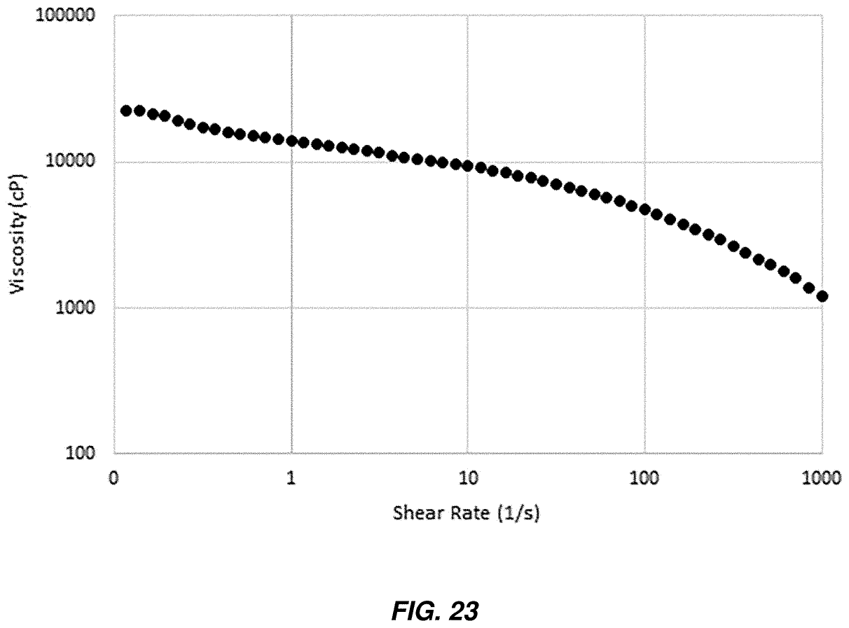

FIG. 23 illustrates a Flow curve of a slurry containing a TMCCC, conductive carbon, graphite, and hydrogenated styrene isoprene butadiene.

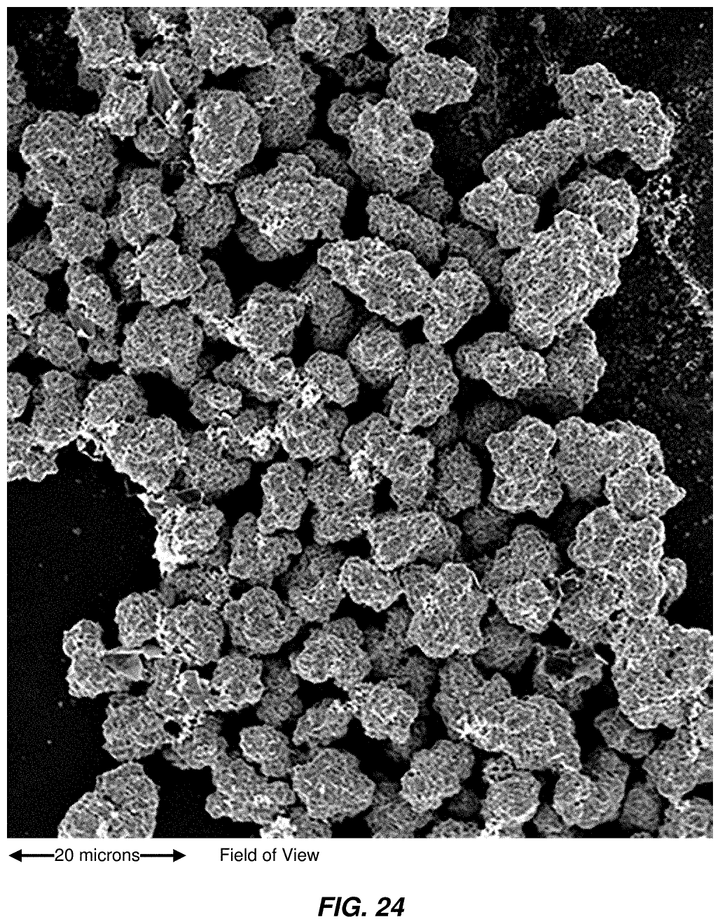

FIG. 24 illustrates a Scanning Electron Microscope image of a slurry containing a TMCCC, conductive carbon, graphite, and hydrogenated styrene isoprene butadiene.

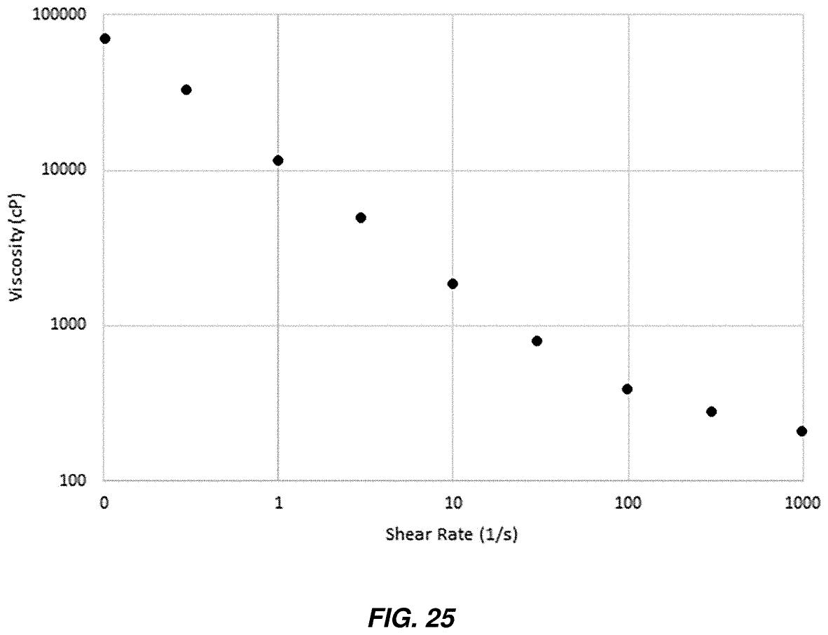

FIG. 25 illustrates a Flow curve of a slurry containing a TMCCC, conductive carbon, ethylene-propylene dicyclopentadiene terpolymer, ethylene-propylene ethylidene norbornene terpolymer, and styrene-ethylene/butylene-styrene.

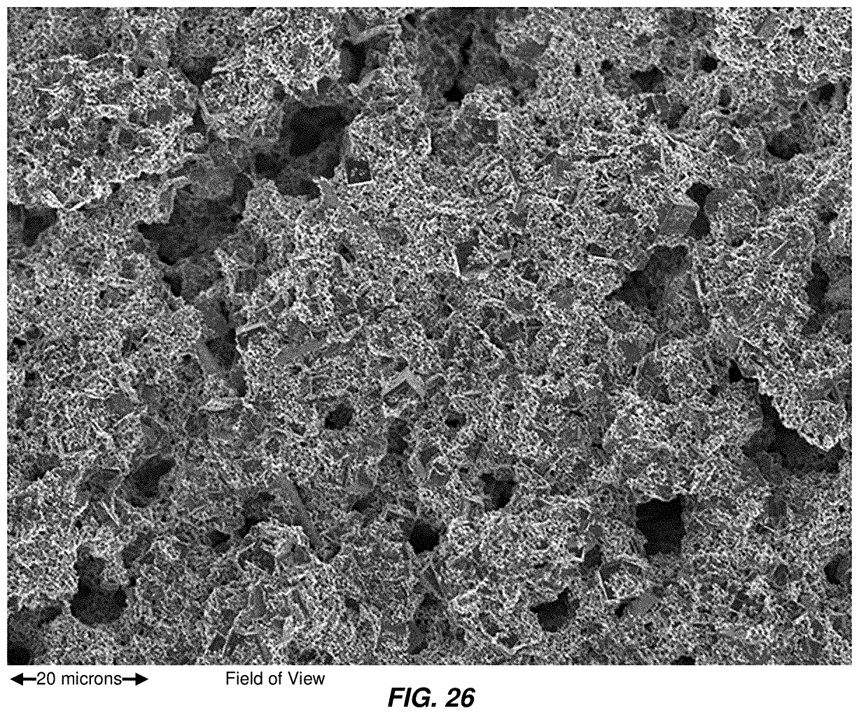

FIG. 26 illustrates a Scanning Electron Microscope image of a slurry containing a TMCCC, conductive carbon, ethylene-propylene dicyclopentadiene terpolymer, ethylene-propylene ethylidene norbornene terpolymer, and styrene-ethylene/butylene-styrene.

### Example 1

48.3 g decahydronaphthalene, 6.1 g 1,2,4-trimethylbenzene, and 17.2 g cyclohexanone were combined in a glass bottle with a magnetic stir bar and placed on a stir plate to mix. 3.5 g linear styrene-ethylene/butylene-styrene with a styrene to rubber ratio of 33:67 and functionalized with a maleic anhydride pendant group (0.95-1.15% by weight) was added to the bottle while it was stirring. The solution was left for 2 hours to dissolve. 21.4 g of the binder solution was added to a plastic container using a pipette. 0.35 g graphite was added to the container. The container was placed in a centrifugal mixer and mixed for 2 minutes at 2000 RPM. 1.04 g carbon black was added to the container, which was then mixed for 10 minutes at 2500 RPM. Finally, 13 g of a TMCCC was added to the container, which was then mixed for 10 minutes at 2500 RPM. 2.3 mL of slurry was removed using a syringe and the flow curve was measured using a rheometer (See FIG. 4). The remainder of the slurry was coated on aluminum foil using a doctor blade on a vacuum-enabled drawdown coater. The slurry was left to dry at 60° C. for 30 minutes. A 1 cm×3 cm piece was cut to bend over a mandrel to verify coat cohesion and adhesion (See FIG. 5). A 3 mm×3 mm piece was imaged using a scanning electron microscope (SEM) (See FIG. 6 and FIG. 7). 3.4×4.4 cm electrodes were punched from the coat and 3 cells were built using activated charcoal, a separator, and electrolyte. The cells were charged to 50% state of charge (SOC) on an Arbin Instruments battery tester and then electrochemical impedance spectroscopy was run using a BioLogic battery tester (See FIG. 8).

### Example 2

14.1 kg decahydronaphthalene, 1.77 kg 1,2,4-trimethylbenzene, and 5 kg cyclohexanone were placed in a stainless-steel vessel and mixed using a high-speed disperser blade at 200 RPM. 426 g linear styrene-ethylene/butylene-styrene with a styrene to rubber ratio of 30:70 was added to the vessel and left to dissolve for 1 hour with the mixer at 700 RPM. 426 g linear styrene-ethylene/butylene-styrene with a styrene to rubber ratio of 33:67 and functionalized with a maleic anhydride pendant group (0.95%-1.15% by weight) was added to the vessel and the solution was left to dissolve for 2 hours. 298 g graphite was added to the vessel and dispersed for 15 minutes at 800 RPM. 15 kg TMCCC was added to the vessel and dispersed for 1 hour at 1000 RPM. 895 g carbon black was added to the vessel and dispersed for 2 hours at 1000 RPM. The vessel was left overnight with the mixer at 800 RPM. The slurry was pumped to a slot die coating head and deposited on an aluminum foil moving at a speed of 8 feet per minute. The coated foil was conveyed through 3 convection drying zones with temperature set points of 151, 88, and 99° C., respectively. A 3 mm×3 mm piece was imaged using a scanning electron microscope (SEM) (See FIG. 9). A small piece was dipped in liquid nitrogen for 30 seconds and then cut with a razor blade in order to image a cross-section (See FIG. 10). 3.4×4.4 cm electrodes were punched from the coat and 3 cells were built using activated charcoal, a separator, and electrolyte. The cells were charged to 50% state of charge (SOC) on an Arbin Instruments battery tester and then electrochemical impedance spectroscopy was run using a BioLogic battery tester (See FIG. 11).

### Example 3

48.7 g decahydronaphthalene and 7.6 g butanol were combined in a glass bottle with a magnetic stir bar and placed on a stir plate to mix. 0.4 g linear styrene-ethylene/butylene-styrene with a styrene to rubber ratio of 33:67 and functionalized with a maleic anhydride pendant group (0.95%4.15% by weight), 1.7 g linear styrene-ethylene/butylene-styrene with a styrene to rubber ratio of 30:70 and a high molecular weight (viscosity in 15 wt % toluene of >30,000 cP), and 1.7 g linear styrene-ethylene/butylene-styrene with a styrene to rubber ratio of 30:70 and a low molecular weight (viscosity in 15 wt % toluene of 30 cP) were added to the bottle while it was stirring. The solution was left overnight to dissolve. 20.9 g of the binder solution was added to a plastic container using a pipette. 1.09 g carbon black was added to the container, which was then mixed in a centrifugal mixer for 10 minutes at 2500 RPM. Finally, 15 g of a TMCCC was added to the container, which was mixed for 5 minutes at 2000 RPM then 5 minutes at 1375 RPM. 2.3 mL of slurry was removed using a syringe and the flow curve was measured using a rheometer (See FIG. 12). The remainder of the slurry was coated on aluminum foil using a doctor blade on a vacuum-enabled drawdown coater. The slurry was left to dry at 60° C. for 30 minutes. A small piece was dipped in liquid nitrogen for 30 seconds and then cut with a razor blade in order to image a cross-section via SEM (See FIG. 13). 3×4 cm electrodes were punched from the coat and 3 cells were built using activated charcoal, a separator, and electrolyte. The cells were cycled on an Arbin Instruments battery tester (See FIG. 14) and then electrochemical impedance spectroscopy was run using a BioLogic battery tester (See FIG. 15).

### Example 4

574.5 g decahydronaphthalene and 89.7 g butanol were combined in a glass bottle with a magnetic stir bar and placed on a stir plate to mix. 10.8 g linear styrene-ethylene/butylene-styrene with a styrene to rubber ratio of 33:67 and functionalized with a maleic anhydride pendant group (0.95%-1.15% by weight), 4.1 g linear styrene-ethylene/butylene-styrene with a styrene to rubber ratio of 30:70, and 21.0 g linear styrene-ethylene/propylene-styrene with a styrene to rubber ratio of 20:80 were added to the bottle while it was stirring. The solution was left overnight to dissolve. 17.9 g of the binder solution was added to a plastic container using a pipette. 1.09 g carbon black was added to the container, which was then mixed for 10 minutes in a centrifugal mixer at 2500 RPM. Finally, 15 g of a TMCCC was added to the container, which was mixed for 5 minutes at 2000 RPM then 5 minutes at 1375 RPM. 2.3 mL of slurry was removed using a syringe and the flow curve was measured using a rheometer (See FIG. 16). The remainder of the slurry was coated on aluminum foil using a doctor blade on a vacuum-enabled drawdown coater. The slurry was left to dry at 60° C. for 30 minutes. 3×4 cm electrodes were punched from the coat and 3 cells were built using activated charcoal, a separator, and electrolyte. The cells were cycled on an Arbin Instruments battery tester (See FIG. 17) and then electrochemical impedance spectroscopy was run using a BioLogic battery tester (See FIG. 18).

### Example 5

57.4 g decahydronaphthalene was placed in a glass bottle with a magnetic stir bar and placed on a stir plate to mix. 2.0 g ethylene/propylene with a star structure (consisting of a center from which multiple polymer chains radiate) and 0.7 g linear styrene-ethylene/butylene-styrene with a styrene to rubber ratio of 30:70 were added to the bottle while it was stirring. The solution was left overnight to dissolve. 17 g of the binder solution was added to a plastic container using a pipette. 1.09 g carbon black was added to the container, which was then mixed for 10 minutes in a centrifugal mixer at 2500 RPM. Finally, 15 g of a TMCCC was added to the container, which was mixed for 5 minutes at 2000 RPM then 5 minutes at 1375 RPM. 0.35 mL of slurry was removed using a syringe and dispensed into a falcon tube containing 13 mL of decahydronaphthalene. The falcon tube was vigorously agitated then 25 μL of the suspension was pipetted using a micropipette onto a silicon wafer on a hot plate set to 60° C. Once the solvent evaporated, the wafer was mounted on a stub and imaged using SEM (See FIG. 19) 2.3 mL of slurry was removed using a syringe and the flow curve was measured using a rheometer (See FIG. 20). The remainder of the slurry was coated on aluminum foil using a doctor blade on a vacuum-enabled drawdown coater. The slurry was left to dry at 60° C. for 30 minutes. 3×4 cm electrodes were punched from the coat and 3 cells were built using activated charcoal, a separator, and electrolyte. The cells were cycled on an Arbin Instruments battery tester (See FIG. 21) and then electrochemical impedance spectroscopy was run using a BioLogic battery tester (See FIG. 22).

### Example 6

37.4 g decahydronaphthalene, 4.7 g 1,2,4-trimethylbenzene, and 13.3 g cyclohexanone were combined in a glass bottle with a magnetic stir bar and placed on a stir plate to mix. 4.6 g linear hydrogenated styrene isoprene butadiene with a styrene to rubber ratio of 30/70 was added to the bottle while it was stirring. The solution was left for 2 hours to dissolve. 15.8 g of the binder solution was added to a plastic container using a pipette along with 4.5 g of the solvent mixture. 0.26 g graphite was added to the container. The container was placed in a centrifugal mixer and mixed for 2 minutes at 2000 RPM. 0.8 g carbon black was added to the container, which was then mixed for 10 minutes at 2500 RPM. Finally, 13 g of a TMCCC was added to the container, which was then mixed for 10 minutes at 2500 RPM. 2.3 mL of slurry was removed using a syringe and the flow curve was measured using a rheometer (See FIG. 23). 0.35 mL of slurry was removed using a syringe and dispensed into a falcon tube containing 13 mL of decahydronaphthalene. The falcon tube was vigorously agitated then 25 μL of the suspension was pipetted using a micropipette onto a silicon wafer on a hot plate set to 60° C. Once the solvent evaporated, the wafer was mounted on a stub and imaged using SEM (See FIG. 24). The remainder of the slurry was coated on aluminum foil using a doctor blade on a vacuum-enabled drawdown coater. The slurry was left to dry at 60° C. for 30 minutes.

### Example 7

1075 g toluene and 360 g xylene were placed in a glass beaker and mixed using a high-speed disperser blade at 200 RPM. 25.4 g ethylene-propylene dicyclopentadiene terpolymer, 25.3 g ethylene-propylene ethylidene norbornene terpolymer, and 7.2 g linear styrene-ethylene/butylene-styrene with a styrene to rubber ratio of 30:70 were added to the beaker and left to dissolve overnight. The following morning, 58 g carbon black was added to the vessel and dispersed for 1 hour at 2000 RPM. Finally, 655 g TMCCC was added to the vessel and dispersed for 1 hour at 2000 RPM. 2.3 mL of slurry was removed using a syringe and the flow curve was measured using a rheometer (See FIG. 25). The remainder of the slurry was poured into a reservoir and coated on a knife-over-roll coater at a temperature of 60° C. A 3 mm×3 mm piece was imaged using a scanning electron microscope (SEM) (See FIG. 26).

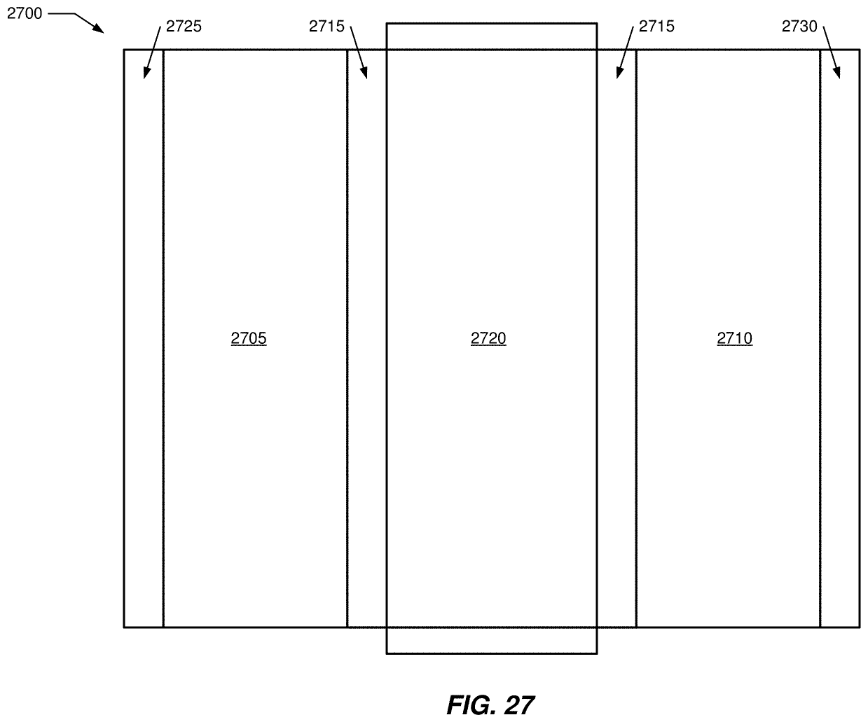

FIG. 27 illustrates a generic electrochemical cell 2700. Cell 2700 includes a first electrode 2705 (e.g., a cathode electrode), a second electrode 2710 (e.g., an anode electrode), a liquid electrolyte 2715, a separator 2720, a first current collector 2725, and a second current collector 2730. One or both electrodes include a coordination compound, and more specifically a transition metal cyanide coordination compound.

The system and methods above have been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention is not limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

1. An electrochemical cell, comprising:
a first electrode and a second electrode, each said electrode including a conductive composite and wherein each said conductive composite includes an electrochemically active material including a transition metal cyanide coordination compound;
a liquid electrolyte in electrical communication with said electrodes, said liquid electrolyte including a mononitrile solvent; and
a binder system included with each said conductive composite as a monolayer, said binder system including two or more polymers each selected from a thermoplastic elastomer family;
wherein each of said two or more polymers of said binder system is independently configured for distribution within said electrically conductive structure.

2. The electrochemical cell of claim 1 wherein said conductive material consists of one or more structures selected from the group including a nanocarbon, a graphite, a carbon nanofiber, a carbon nanotube, and combinations thereof.

3. The electrochemical cell of claim 1 wherein one of said two or more polymers includes a block co-polymer.

4. The electrochemical cell of claim 1 wherein one of said two or more polymers in said binder system includes a styrenic block copolymer.

5. The electrochemical cell of claim 1 wherein one of said two or more polymers includes a block co-polymer functionalized with polar side groups.

6. The electrochemical cell of claim 1 wherein each of the two or more polymers of said binder system includes a block co-polymer, said two or more polymers included as a mixture.

7. The electrochemical cell of claim 6 wherein at least one of said two or more polymers including said block co-polymer is functionalized with polar side groups.

8. The electrochemical cell of claim 1 wherein said binder system includes an elastomeric component, said elastomeric component including a synthetic rubber, a natural rubber, or a combination thereof.

9. The electrochemical cell of claim 6 wherein said binder system further includes an elastomeric component, said elastomeric component including a synthetic rubber, a natural rubber, or a combination thereof.

10. The electrochemical cell of claim 7 wherein said binder system further includes an elastomeric component, said elastomeric component including a synthetic rubber, a natural rubber, or a combination thereof.

11. An electrochemical cell comprising a positive electrode, a negative electrode, and a liquid electrolyte including a mononitrile solvent, wherein one of the electrodes includes a transition metal cyanide coordination compound, a conductive material, and a binder system including two or more polymers each selected from a thermoplastic elastomer family, wherein each said polymer of said binder system is independently configured for distribution within said electrically conductive structure.

12. The electrochemical cell of claim 11 wherein said conductive material consists of one or more structures selected from the group including a nanocarbon, a graphite, a carbon nanofiber, a carbon nanotube, and combinations thereof.

13. The electrochemical cell of claim 11 wherein one of said two or more polymers in said binder system includes a block co-polymer.

14. The electrochemical cell of claim 11 wherein one of said two or more polymers in said binder system includes a styrenic block copolymer.

15. The electrochemical cell of claim 11 wherein one of said two or more polymers in said binder system includes a block co-polymer functionalized with polar side groups.

16. The electrochemical cell of claim 11 wherein each of said two or more polymers of said binder system includes a block co-polymer, said two or more polymers included as a mixture.

17. The electrochemical cell of claim 16 wherein at least one of said two or more block co-polymers polymers including said block co-polymer is functionalized with polar side groups.

18. The electrochemical cell of claim 11 wherein said binder system includes an elastomeric component, said elastomeric component including a synthetic rubber, a natural rubber, or a combination thereof.

19. The electrochemical cell of claim 16 wherein said binder system further includes an elastomeric component, said elastomeric component including a synthetic rubber, a natural rubber, or a combination thereof.

20. The electrochemical cell of claim 17 wherein said binder system further includes an elastomeric component, said elastomeric component including a synthetic rubber, a natural rubber, or a combination thereof.

21. A method manufacturing an electrochemical cell, comprising the steps of:
a) providing an electrochemically active material including a transition metal cyanide coordination compound;
b) providing a conductive material; and
c) binding non-laminatingly said electrochemically active material to said conductive material using a binder system that includes two or more polymers each selected from a thermoplastic elastomer family, wherein each said polymer of said binder system is independently configured for distribution within said electrically conductive structure producing a first electrode and a second electrode;
d) communicating said electrodes with a liquid electrolyte including a mononitrile solvent.

22. The electrochemical cell of claim 1 wherein said mononitrile solvent includes acetonitrile.

23. The electrochemical cell of claim 11 wherein said mononitrile solvent includes acetonitrile.

24. The method of claim 21 wherein said mononitrile solvent includes acetonitrile.
